(19) United States
(12) Patent Application Publication
(10) Pub. No.: US 2021/0276383 A1
(43) Pub. Date: Sep. 9, 2021

(54) LEADING-EDGE FRONT SUSPENSION

(71) Applicant: Robby Gordon, Charlotte, NC (US)

(72) Inventor: Robby Gordon, Charlotte, NC (US)

(21) Appl. No.: 17/196,867

(22) Filed: Mar. 9, 2021

Related U.S. Application Data
(60) Provisional application No. 62/987,282, filed on Mar. 9, 2020.

(51) Int. Cl. B60G 3/20; B60G 7/00

(52) U.S. Cl. CPC B60G 3/20; B60G 7/001; B60G 2206/80; B60G 2800/162; B60G 2200/144; B60G 2206/124; B60G 2300/07; B60G 2200/17

(57) ABSTRACT

An apparatus and methods are provided for a leading-edge front suspension system to improve the mechanical strength and performance of off-road vehicles. The leading-edge front suspension system comprises upper and lower connecting arms that couple front wheels with a chassis of a vehicle. The upper and lower connecting arms are swept rearward relative to the chassis so as to accommodate coupling struts between the lower connecting arms and the chassis. The lower connecting arms are reinforced to withstand forces arising due to the front wheels and the struts during traveling over terrain. The upper connecting arms are configured to accommodate the struts extending between the lower connecting arms and the chassis. Coupling the struts with the lower connecting arms facilitates a lower center of gravity of the off-road vehicle and advantageously positions the struts with respect to the lower connecting arms during full compression of the struts.

### PRIORITY

This application claims the benefit of and priority to U.S. Provisional Application, entitled “Leading-Edge Front Suspension,” filed on Mar. 9, 2020 and having application Ser. No. 62/987,282, the entirety of said application being incorporated herein by reference.

### FIELD

The field of the present disclosure generally relates to vehicle suspension systems. More particularly, the field of the invention relates to a leading-edge front suspension system configured to improve the mechanical strength and performance of off-road drivetrains.

### BACKGROUND

A double wishbone suspension is a well-known independent suspension design using upper and lower wishbone-shaped arms to operably couple a front wheel of a vehicle. Typically, the upper and lower wishbones or suspension arms each has two mounting points to a chassis of the vehicle and one mounting joint at a spindle assembly or knuckle. A shock absorber and a coil spring may be mounted onto the wishbone to control vertical movement of the front wheel. The double wishbone suspension facilitates control of wheel motion throughout suspension travel, including controlling such parameters as camber angle, caster angle, toe pattern, roll center height, scrub radius, scuff, and the like.

Double wishbone suspensions may be used in a wide variety of vehicles, including heavy-duty vehicles, as well as many off-road vehicles, as shown in FIG. 1. FIG. 1 shows an off-road vehicle 100 that is of a Side-by-Side variety. The Side by Side is a four-wheel drive off-road vehicle that typically seats between two and six occupants and is sometimes referred to as a Utility Task Vehicle (UTV), a Recreational Off-Highway Vehicle (ROV), or a Multipurpose Off-Highway Utility Vehicle (MOHUV). In addition to the side-by-side seating arrangement, many UTVs have seat belts and roll-over protection, and some may have a cargo box at the rear of the vehicle. A majority of UTVs come factory equipped with hard tops, windshields, and cab enclosures.

The double-wishbone suspension often is referred to as “double A-arms”, although the arms may be A-shaped, L-shaped, J-shaped, or even a single bar linkage. In some embodiments, the upper arm may be shorter than the lower arm so as to induce negative camber as the suspension jounces (rises). Preferably, during turning of the vehicle, body roll imparts positive camber gain to the lightly loaded inside wheel, while the heavily loaded outer wheel gains negative camber.

The spindle assembly, or knuckle, is coupled between the outboard ends of the upper and lower suspension arms. In some designs, the knuckle contains a kingpin that facilitates horizontal radial movement of the wheel, and rubber or trunnion bushings for vertical hinged movement of the wheel. In some relatively newer designs, a ball joint may be disposed at each outboard end to allow for vertical and radial movement of the wheel. A bearing hub, or a spindle to which wheel bearings may be mounted, may be coupled with the center of the knuckle.

Constant velocity (CV) joints allow pivoting of the suspension arms and the spindle assembly, while a drive shaft coupled to the CV joint delivers power to the wheels. Although CV joints are typically used in front wheel drive vehicles, off-road vehicles such as four-wheeled buggies comprise CV joints at all wheels. Constant velocity joints typically are protected by a rubber boot and filled with molybdenum disulfide grease.

Given that off-road vehicles routinely travel over very rough terrain, such as mountainous regions, there is a desire to improve the mechanical strength and performance of off-road drivetrain and suspension systems, while at the same reducing the mechanical complexity of such systems.

### SUMMARY

An apparatus and methods are provided for a leading-edge front suspension system to improve the mechanical strength and performance of off-road vehicles. The leading-edge front suspension system comprises upper and lower connecting arms that couple front wheels with a chassis of a vehicle. The upper and lower connecting arms are swept rearward relative to the chassis so as to accommodate coupling struts between the lower connecting arms and the chassis. The lower connecting arms are reinforced to withstand forces arising due to the front wheels and the struts during traveling over terrain. The upper connecting arms are configured to accommodate the struts extending between the lower connecting arms and the chassis. Experimental observations have demonstrated that coupling the struts with the lower connecting arms facilitates a lower center of gravity of the off-road vehicle and advantageously positions the struts with respect to the lower connecting arms during full compression of the struts.

In an exemplary embodiment, a leading-edge front suspension system for an off-road vehicle comprises: a spindle assembly coupled with each front wheel; an upper connecting arm hingedly coupling a top of the spindle assembly with a chassis; a lower connecting arm hingedly coupling a bottom of the spindle assembly with the chassis; and a strut coupled between the lower connecting arm and the chassis.

In another exemplary embodiment, the upper connecting arm includes two inboard mounting joints to the chassis and one outboard mounting joint to the spindle assembly. In another exemplary embodiment, the inboard mounting joints are bushing joints configured to allow vertical movement of the upper connecting arm with respect to the chassis. In another exemplary embodiment, the outboard mounting joints comprise rod-end joints configured to allow vertical and horizontal movement of the spindle assembly with respect to the chassis.

In another exemplary embodiment, the upper connecting arm includes a sweep angle that positions the outboard mounting joint rearward of a midpoint between the inboard mounting joints. In another exemplary embodiment, the sweep angle is configured to accommodate the strut extending between the lower connecting arm and the chassis and position the outboard mounting joint to be coupled with the spindle assembly. In another exemplary embodiment, the inboard mounting joints are positioned forward of inboard mounting joints comprising the lower connecting arm such that the sweep angle is greater that a sweep angle of the lower connecting arm.

In another exemplary embodiment, the lower connecting arm includes two inboard mounting joints to the chassis and one outboard mounting joint to the spindle assembly. In another exemplary embodiment, the inboard mounting joints are bushing joints configured to allow vertical movement of the lower connecting arm with respect to the chassis. In another exemplary embodiment, the outboard mounting joints comprise rod-end joints configured to allow vertical and horizontal movement of the spindle assembly with respect to the chassis. In another exemplary embodiment, the lower connecting arm includes a lower pivot configured to receive the strut. In another exemplary embodiment, the lower connecting arm is reinforced to withstand forces arising due to the front wheel and the strut during traveling over terrain. In another exemplary embodiment, the lower connecting arm is swept rearward at an angle relative to the chassis so as to accommodate receiving the strut. In another exemplary embodiment, the outboard mounting joint is positioned rearward of a midpoint between the inboard mounting joints, giving the lower connecting arm a sweep angle.

In an exemplary embodiment, a method for a leading-edge front suspension system for an off-road vehicle comprises: coupling a spindle assembly with each front wheel; configuring an upper connecting arm to hingedly couple a top of the spindle assembly with a chassis; configuring a lower connecting arm to hingedly couple a bottom of the spindle assembly with the chassis; and mounting a strut between the lower connecting arm and the chassis.

In another exemplary embodiment, configuring the upper connecting arm includes forming a rearward sweep angle comprising the upper connecting arm so as to accommodate the strut extending between the lower connecting arm and the chassis. In another exemplary embodiment, configuring the upper connecting arm includes mounting the upper connecting arm to the chassis in a position forward of the lower connecting arm. In another exemplary embodiment, configuring the lower connecting arm includes reinforcing the lower connecting arm to withstand forces arising due to the front wheel and the strut during traveling over terrain. In another exemplary embodiment, configuring the lower connecting arm includes forming a rearward sweep angle comprising the lower connecting arm so as to accommodate receiving the strut.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates an exemplary embodiment of an off-road vehicle that is particularly suitable for implementation of an off-road front suspension system in accordance with the present disclosure;

FIG. 2 illustrates a front view of a leading-edge front suspension system that is configured to couple a front wheel with a passenger side of an off-road vehicle;

FIG. 3 illustrates a front view of an exemplary embodiment of outboard rod-end joints coupling a spindle assembly with upper and lower suspension arms;

FIG. 4 illustrates a bottom view of an exemplary embodiment of a leading-edge front suspension system that is configured to couple a front wheel with a driver side of an off-road vehicle; and

FIG. 5 illustrates an upper view of an exemplary embodiment of a leading-edge front suspension system that is configured to couple a front wheel with a passenger side of an off-road vehicle.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first joint,” may be made. However, the specific numeric reference should not be interpreted as a literal sequential order but rather interpreted that the “first joint” is different than a “second joint.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, the present disclosure describes a suspension for coupling a front wheel with a chassis of an off-road vehicle. The suspension comprises an upper suspension arm that includes two inboard mounting points to the chassis and one outboard rod-end joint to a spindle assembly coupled with the front wheel. A lower suspension arm comprises two inboard mounting points to the chassis and one outboard rod-end joint to the spindle assembly. Each outboard rod-end joint is comprised of a ball that is rotatable within a casing that is threadably coupled with each of the upper and lower suspension arms. A bolt fastens each of the balls between a pair of parallel prongs extending from the spindle assembly, such that the upper and lower suspension arms may pivot with respect to the spindle assembly during vertical motion of the spindle assembly, as well as during horizontal rotation of the spindle assembly due to steering. A strut comprising a shock absorber and a coil spring is coupled between the lower suspension arm and the chassis. The upper suspension arm is configured to facilitate coupling the strut between the lower suspension arm and the chassis. A steering rod is coupled with the spindle assembly by way of a steering rod-end joint that is disposed at a front of the spindle assembly. The steering rod-end joint is comprised of a ball that is rotatable within a casing that is threadably coupled with the steering rod. A pair of parallel prongs and a bolt hingedly couple the steering rod-end with the spindle assembly, such that the steering rod-end joint allows vertical and horizontal rotational motion of the spindle assembly during operation of the off-road vehicle. The steering rod-end joint is coupled with the spindle assembly forward of a drive axle, thereby decreasing leverage of the front wheel on the steering rod and substantially eliminating bump steer that may occur due to rough terrain.

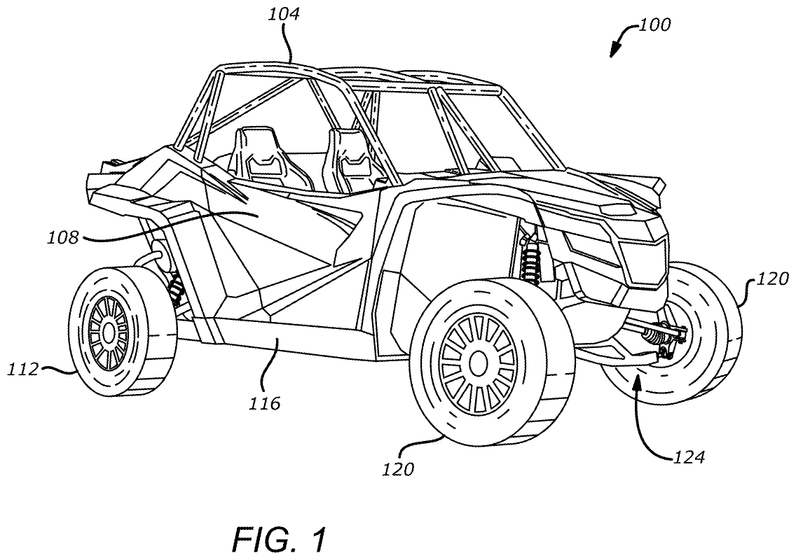

FIG. 1 shows an off-road vehicle 100 that is particularly suitable for implementation of a leading-edge front suspension system in accordance with the present disclosure. As disclosed hereinabove, the off-road vehicle 100 generally is of a Utility Task Vehicle (UTV) variety that seats two occupants, includes a roll-over protection system 104, and may have a cab enclosure 108. Rear wheels 112 of the off-road vehicle 100 may be operably coupled with a chassis 116 by way of a trailing arm suspension system. Front wheels 120 may be operably coupled with the chassis 116 by way of a leading-edge front suspension system 124 disclosed herein. It should be understood, however, that the leading-edge front suspension system 124 of the present disclosure is not to be limited to the off-road vehicle 100, but rather the leading-edge front suspension system 124 may be incorporated into a wide variety of off-road vehicles, other than UTVs, without limitation.

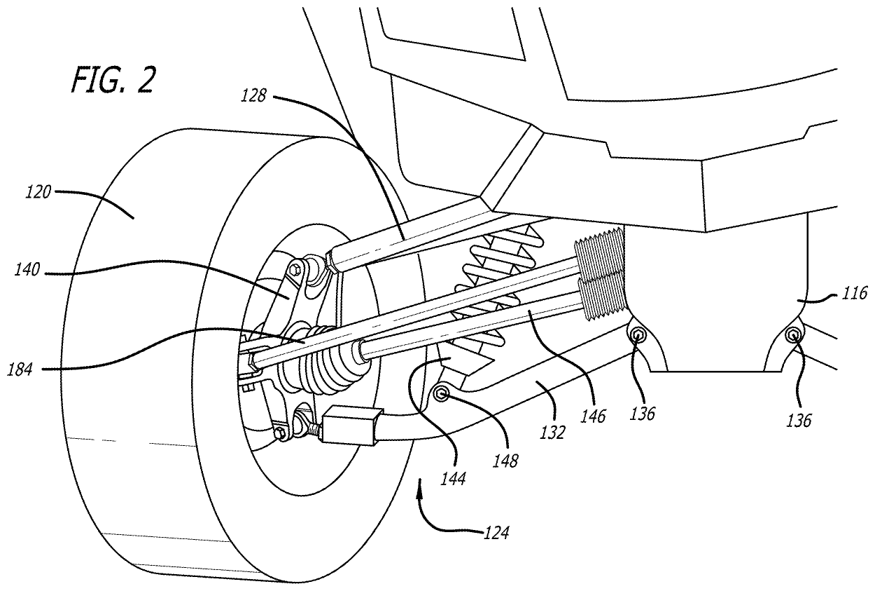

FIG. 2 illustrates a front view of a leading-edge front suspension system 124 that is configured to couple the front wheel 120 with a passenger side of the off-road vehicle 100. The leading-edge front suspension system 124 includes an upper connecting arm 128 and a lower connecting arm 132 that couple the front wheel 120 with the chassis 116. Each of the upper and lower connecting arms 128, 132 comprises two inboard mounting points 136 to the chassis 116 and one outboard mounting joint to a spindle assembly 140. As will be recognized, the upper and lower connecting arms 128, 132 generally are of a double wishbone variety of suspension that facilitates controlling various parameters affecting the orientation of the wheel 120 with respect to the off-road vehicle 100, such as, by way of non-limiting example, camber angle, caster angle, toe pattern, roll center height, scrub radius, and scrub.

Moreover, it should be understood that although the leading-edge front suspension system 124 is disclosed specifically in connection with the passenger side of the off-road vehicle 100, a driver side front suspension system is to be coupled with a driver side of the off-road vehicle. It should be further understood that the driver side front suspension system is substantially identical to the leading-edge front suspension system 124, with the exception that the driver side front suspension system is configured specifically to operate with the driver side of the off-road vehicle 100. As will be appreciated, therefore, the driver side front suspension system and the suspension system 124 may be configured as reflections of one another across a longitudinal midline of the off-road vehicle 100.

As shown in FIG. 2, a strut 144 including a shock absorber and a coil spring is mounted to the lower connecting arm 132 by way of a lower pivot 148. An upper pivot (not shown) couples a top of the strut 144 to the chassis 116. The strut 144 is configured to control vertical motion of the leading-edge front suspension system 124 due to movement of the front wheel 120 as the off-road vehicle 100 travels over terrain. The upper connecting arm 128 may be suitably configured, such as in the form of a J-arm, so as to facilitate coupling the strut 144 between the lower connecting arm 132 and the chassis 116 in lieu of being coupled between the upper connecting arm and the chassis.

In some embodiments, coupling the strut 144 with the lower connecting arm 132 positions the strut at between 8 inches and 10 inches lower, with respect to the chassis 116, than the position of the strut when coupled with the upper connecting arm 128. Experimental observation has shown that the lower position of the strut 144 generally facilitates a lower center of gravity of the off-road vehicle 100 and a relatively smaller shock angle, as well as eliminating a need for extending the strut towers through and above a hood of the off-road vehicle 100. In one embodiment, the coupling of the strut 144 with the lower connecting arm 132 positions the strut at substantially 90-degrees with respect to the lower pivot 148 and the upper pivot during full compression of the strut.

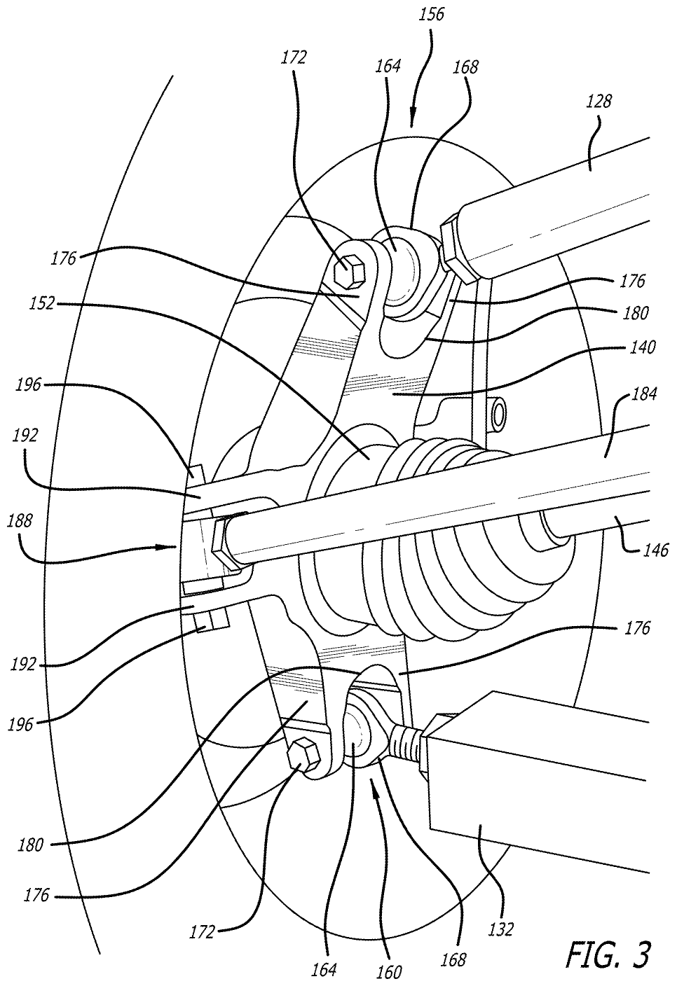

As shown in FIG. 2, a drive axle 146 is coupled between a transaxle and the front wheel 120. The drive axle 146 is configured to conduct torque from the transaxle to the front wheel 120 and accommodate vertical pivoting motion of the leading-edge front suspension assembly 124 in response to road conditions. As best shown in FIG. 3, the drive axle 146 includes a constant velocity (CV) joint 152 that is coupled with the spindle assembly 140 onto which the front wheel 120 is mounted. The CV joint 152 allows uninterrupted torque transmission from the transaxle to the front wheel 120 during vertical pivoting of the leading-edge front suspension assembly 124 due to road conditions. As will be appreciated, the spindle assembly 140 generally supports the CV joint 152 and the front wheel 120 by way of one or more roller bearings (not shown).

As further shown in FIG. 3, the spindle assembly 140 is pivotally coupled with the upper and lower connecting arms 128, 132. An upper rod-end joint 156 couples the upper connecting arm 128 to the spindle assembly 140, and a lower rod-end joint 160 couples the lower connecting arm 132 to the spindle assembly. Preferably, the upper and lower rod-end joints 156, 160 are of a Heim joint variety, wherein each of the joints is comprised of a ball 164 that is movable within a casing 168 that is threadably coupled with each of the connecting arms 128, 132. A bolt 172 fastens each of the balls 164 between a pair of parallel prongs 176 extending from the spindle assembly 140. It is contemplated that a recess 180 disposed between each pair of parallel prongs 176 has a shape and a size that are suitable to fixedly receive the ball 164 and allow for a desired degree of movement of the casing 168 on the ball. Thus, during vertical motion of the spindle assembly 140, as well as during horizontal rotation of the spindle assembly 140 due to steering, the balls 164 rotate within their respective casings 168, allowing the upper and lower connecting arms 128, 132 to pivot with respect to the spindle assembly 140.

Upon inspection of FIG. 3, it will be recognized that the upper and lower rod-end joints 156, 160 are similar to Clevis fasteners. For example, each pair of parallel prongs 176 is similar to a Clevis, the bolt 172 is similar to a Clevis pin, and the ball 164 and casing 168 are similar to a tang. As such, each of the upper and lower rod-end points 156, 160 provides two shear planes that may withstand twice the incident force that may be withstood by single shear joints that are used in conventional front suspensions.

In the embodiment illustrated in FIG. 3, a steering rod 184 couples the spindle assembly 140 with a steering system of the off-road vehicle 100. The steering rod 184 is coupled with the spindle assembly 140 by way of a rod-end joint 188 that is similar to the upper and lower rod-end joints 156, 160. It is contemplated, therefore, that the rod-end joint 188 may be of the Heim-joint variety or may be of a bushing variety, as desired. A pair of parallel prongs 192 and a bolt 196 hingedly couple the steering rod 184 with the spindle assembly 140. As will be appreciated, the rod-end joint 188 allows vertical and horizontal rotational motion of the spindle assembly 140 during operation of the off-road vehicle 100. Further, the rod-end joint 188 is coupled with the spindle assembly 140 forward of the drive axle 146, thereby providing a front steering system to the off-road vehicle 100. Experimentation has demonstrated that the front steering system shown in FIG. 3 advantageously decreases leverage of the front wheel 120 on the rod-end joint 188 and the steering rod 184, thereby substantially eliminating bump steer that may occur due to forces exerted on the front wheel by rough terrain.

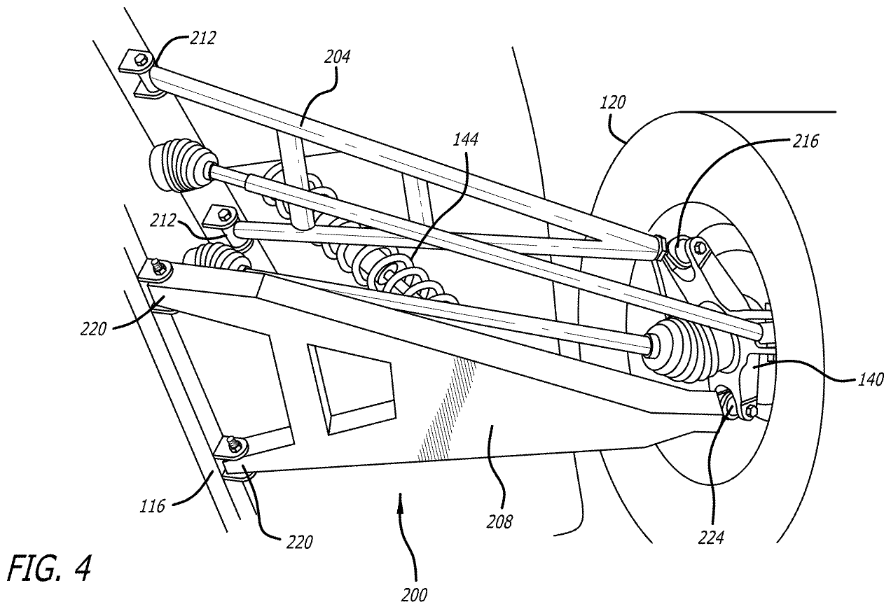

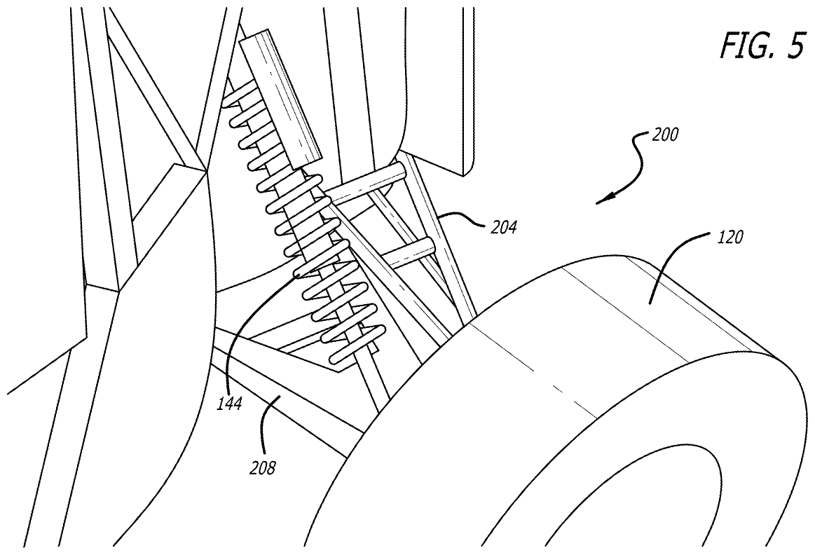

FIGS. 4-5 illustrate an exemplary embodiment of a leading-edge front suspension system 200 that is configured to couple a front wheel 120 with a driver side of an off-road vehicle 100. The suspension system 200 includes an upper connecting arm 204 and a lower 216 connecting arm 208 that couple the front wheel 120 with the chassis 116. The upper connecting arm 204 includes two inboard mounting joints 212 to the chassis 166 and one outboard mounting joint 216 to the spindle assembly 140. The lower connecting arm 208 includes two inboard mounting joints 220 to the chassis and one outboard mounting joint 224 to the spindle assembly 140. The inboard mounting joints 212, 220 generally are of a bushing variety that allows vertical movement of the connecting arms 204, 208 with respect to the chassis 116. The outboard mounting joints 216, 224 may comprise rod-end joints that are substantially identical to the rod-end joints 156, 160. Similar to the upper and lower connecting arms 128, 132, discussed with respect to FIGS. 1-3, the upper and lower connecting arms 204, 208 generally comprise a double wishbone variety of front suspension that facilitates controlling various parameters affecting the orientation of the wheel 120 with respect to the off-road vehicle 100, such as, by way of non-limiting example, camber angle, caster angle, toe pattern, roll center height, scrub radius, scrub, and the like.

As best shown in FIG. 5, a strut 144 including a shock absorber and a coil spring is mounted to the lower connecting arm 208 by way of a lower pivot 148 (see FIG. 3). An upper pivot (not shown) couples a top of the strut 144 to the chassis 116. The strut 144 is configured to control vertical motion of the front suspension system 200 due to movement of the front wheel 120 as the off-road vehicle 100 travels over terrain. As best shown in FIG. 4, the lower connecting arm 208 generally is reinforced to withstand the forces arising due to the front wheel 120 and the strut 144 during traveling over terrain.

In the embodiment illustrated in FIGS. 4-5, the upper and lower connecting arms 204, 208 are configured to facilitate coupling the strut 144 between the lower connecting arm 208 and the chassis 116. Experimental observation has demonstrated that coupling the strut 144 with the lower connecting arm 208 facilitates a lower center of gravity of the off-road vehicle 100 and a smaller shock angle. In some embodiments, coupling the strut 144 with the lower connecting arm 208 advantageously positions the strut 144 at substantially 90-degrees with respect to the lower connecting arm 208 during full compression of the strut 144.

As best shown in FIG. 4, the upper and lower connecting arms 204, 208 generally are swept rearward at an angle relative to the chassis 116, thereby giving the front suspension 200 a leading-edge configuration that accommodates coupling the strut 144 with the lower connecting arm 208, as described herein. More specifically, in one embodiment, the outboard mounting joint 224 is positioned rearward of a midpoint between the inboard mounting joints 220, giving the lower connecting arm 208 a first sweep angle. Similarly, the upper connecting arm 204 includes a second sweep angle that positions the outboard mounting joint 216 rearward of the midpoint between the inboard mounting joints 212. In some embodiments, the inboard mounting joints 212 may be positioned forward of the inboard mounting joints 220. In such embodiments, the sweep angle of the upper connecting arm 204 (i.e., the second sweep angle) may be greater than the first sweep angle of the lower connecting arm 208. It is contemplated that the greater sweep angle of the upper connecting arm 204 serves to accommodate the strut 144 extending between the lower connecting arm 208 and the chassis 116, as well as advantageously positioning the outboard mounting joint 216 to be coupled with the spindle assembly 140. In general, coupling the strut 144 with the lower connecting arm 208 positions the strut between 8 inches and 10 inches lower with respect to the chassis 116, thereby obviating a need for extending strut towers through and above a hood of the off-road vehicle 100.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. A leading-edge front suspension system for an off-road vehicle, the suspension comprising:
a spindle assembly coupled with each front wheel;
an upper connecting arm hingedly coupling a top of the spindle assembly with a chassis;
a lower connecting arm hingedly coupling a bottom of the spindle assembly with the chassis; and
a strut coupled between the lower connecting arm and the chassis.

2. The suspension of claim 1, wherein the upper connecting arm includes two inboard mounting joints to the chassis and one outboard mounting joint to the spindle assembly.

3. The suspension of claim 2, wherein the inboard mounting joints are bushing joints configured to allow vertical movement of the upper connecting arm with respect to the chassis.

4. The suspension of claim 2, wherein the outboard mounting joints comprise rod-end joints configured to allow vertical and horizontal movement of the spindle assembly with respect to the chassis.

5. The suspension of claim 2, wherein the upper connecting arm includes a sweep angle that positions the outboard mounting joint rearward of a midpoint between the inboard mounting joints.

6. The suspension of claim 5, wherein the sweep angle is configured to accommodate the strut extending between the lower connecting arm and the chassis and position the outboard mounting joint to be coupled with the spindle assembly.

7. The suspension of claim 6, wherein the inboard mounting joints are positioned forward of inboard mounting joints comprising the lower connecting arm such that the sweep angle is greater that a sweep angle of the lower connecting arm.

8. The suspension of claim 1, wherein the lower connecting arm includes two inboard mounting joints to the chassis and one outboard mounting joint to the spindle assembly.

9. The suspension of claim 8, wherein the inboard mounting joints are bushing joints configured to allow vertical movement of the lower connecting arm with respect to the chassis.

10. The suspension of claim 8, wherein the outboard mounting joints comprise rod-end joints configured to allow vertical and horizontal movement of the spindle assembly with respect to the chassis.

11. The suspension of claim 8, wherein the lower connecting arm includes a lower pivot configured to receive the strut.

12. The suspension of claim 8, wherein the lower connecting arm is reinforced to withstand forces arising due to the front wheel and the strut during traveling over terrain.

13. The suspension of claim 8, wherein the lower connecting arm is swept rearward at an angle relative to the chassis so as to accommodate receiving the strut.

14. The suspension of claim 8, wherein the outboard mounting joint is positioned rearward of a midpoint between the inboard mounting joints, giving the lower connecting arm a sweep angle.

15. A method for a leading-edge front suspension system for an off-road vehicle, comprising:
coupling a spindle assembly with each front wheel;
configuring an upper connecting arm to hingedly couple a top of the spindle assembly with a chassis;
configuring a lower connecting arm to hingedly couple a bottom of the spindle assembly with the chassis; and
mounting a strut between the lower connecting arm and the chassis.

16. The method of claim 15, wherein configuring the upper connecting arm includes forming a rearward sweep angle comprising the upper connecting arm so as to accommodate the strut extending between the lower connecting arm and the chassis.

17. The method of claim 15, wherein configuring the upper connecting arm includes mounting the upper connecting arm to the chassis in a position forward of the lower connecting arm.

18. The method of claim 15, wherein configuring the lower connecting arm includes reinforcing the lower connecting arm to withstand forces arising due to the front wheel and the strut during traveling over terrain.

19. The method of claim 15, wherein configuring the lower connecting arm includes forming a rearward sweep angle comprising the lower connecting arm so as to accommodate receiving the strut.
